(19) United States
(12) Patent Application Publication
(10) Pub. No.: US 2007/0064437 A1
(43) Pub. Date: Mar. 22, 2007

(54) Enhanced apparatus for reducing in size an igniter circuit and assembly

(76) Inventors: Daniel M. Blumel, Ogden, UT (US); Tung-Hsin Lin, Tao-Yuan City (TW)

Correspondence Address: KIRTON AND MCCONKIE, 60 EAST SOUTH TEMPLE,, SUITE 1800, SALT LAKE CITY, UT, 84111, US

(21) Appl. No.: 11/515,300

(22) Filed: Sep. 1, 2006

Related U.S. Application Data
(63) Continuation-in-part of application No. 11/151,768, filed on Jun. 14, 2005.

(51) Int. Cl. F21V 7/00

(52) U.S. Cl. 362/514

(57) ABSTRACT

The present invention converts a D2 burner to a D1S bulb assembly by reducing the size of the transformer and providing a configuration for releasably attaching the D2 device to the D1S-sized assembly for ready insertion and removal of the D2 burner.

### RELATED APPLICATIONS

This application is a continuation-in-part of pending U.S. patent application Ser. No. 11/151,768 filed Jun. 14, 2005.

### BACKGROUND

1. Field of the Invention

The present application relates to a method and apparatus for converting D2 bulbs to D1S bulbs. Particularly, this invention relates to utilizing a standard D2 bulb with a P32d base for making standard D1S bulbs for automotive, industrial, aviation, and other applications

2. Background of the Invention and Related Art

There currently exists a number of different high-intensity discharge lamps (“HID”) which are used in applications including automobile headlights. HID lamps create several benefits not found in standard halogen lights, including increased visibility, as well as improved safety conditions. These benefits are derived from the use of different halide metals and gasses within a standard HID bulb. HID bulbs are incorporated in many applications, especially where night time vision is critical. However, attempts to broaden the use of HID bulbs have met with several technical difficulties because such bulbs require high voltage and complex starting (igniter) and control circuitry (ballasts). To overcome these technical challenges, the prior art teaches the use of a toroid transformer, which is capable of producing between ten thousand and thirty thousand volts, the amount necessary to start the HID lamp. Also, taught by the prior art are a series of plastic walls within the base of the bulb to create barriers to arcing within the bulb, thus reducing the potential for internal arcing caused by the high voltage.

While these solutions allow the HID to be used in some applications such as car lights, there are still other applications which present problems that are not addressed by the above-mentioned prior art. For example, use of the prior art bulbs results in arcing inside the bulb base when starting at high altitude, especially during hot re-strike. This arcing can destroy the circuitry. Similarly, the prior art fails to address the energy requirements of a pulsating HID light. For example, when the light pulsates, the energy requirements increase dramatically. This drastic increase in energy requirements generates excess heat which also contributes to circuitry failure. Finally, the prior art fails to teach an apparatus or method which allows a user to convert a D2 arc tube with P32d base to a D1S bulb. This is desirable because of the cost savings which would result from using standard, off-the-shelf D2 bulbs. The size difference between these two bulbs has prevented small companies from entering the D1S size bulb market because larger producers are required to produce their own light bulbs (arc tubes) to fit into the D1S bulb size.

The present invention seeks to address the shortcomings of the prior art.

### SUMMARY

The present invention is an apparatus for mounting standard, off-the-shelf D2 bulbs having a P32d-sized base, or any bulb having a P32d-sized base, in D1S bulb fittings or into D1S-sized bulb assemblies. As taught by the present invention, a user takes a D2 bulb and couples to a D1S bulb-sized circuit board having two contact leads fastened thereto. The contact leads may be springs as taught by the present invention, thus the spring can be configured to couple with a P32d-sized base. The circuit board is placed inside a housing, and the burner or arc tube is inserted through a hole in the housing engaging the contact springs. Finally, an outer plastic cover is placed over the burner igniter circuit board and then a metal shield igniter cover assembly is installed on the outside surrounding the entire igniter assembly. The entire burner/circuit board assembly, also known as the igniter, plus the arc tube constitutes a D1S bulb.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates an exploded view of one embodiment of the present invention.

FIG. 2 illustrates an exploded view of another embodiment of the present invention.

### DETAILED DESCRIPTION OF THE PREFERRED EMBODIMENTS

It will be readily understood that the components of the present invention, as generally described and illustrated in the figures herein, could be arranged and designed in a wide variety of different configurations. Thus, the following more detailed description of the embodiments of the system and method of the present invention is not intended to limit the scope of the invention, as claimed, but is merely representative of the presently preferred embodiments of the invention.

The term burner is a burner or arc tube.

The term bulb comprises a burner and an igniter.

The term D2 defines a device having a standard size burner commonly known in the art having a P32d-size base.

The term D1S is a standard bulb size commonly known in the art.

The term igniter assembly refers to a circuit board and the component parts used in starting the high voltage arc within an HID burner.

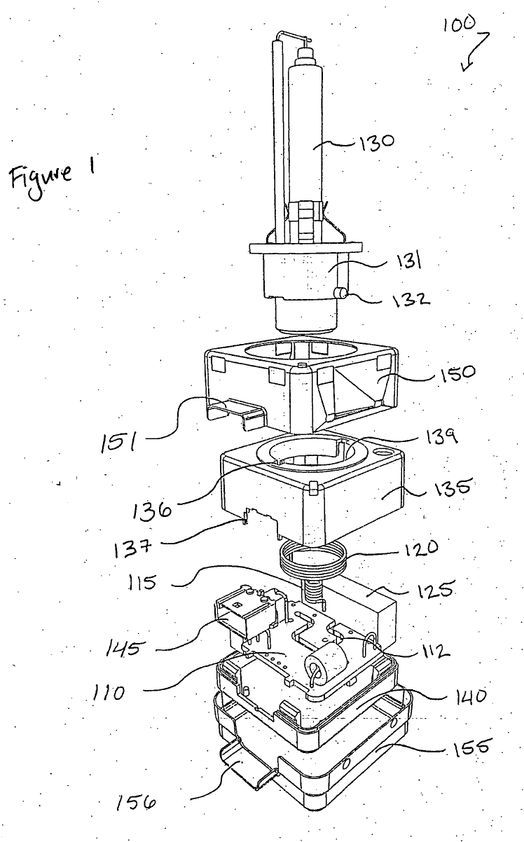

As illustrated in FIG. 1, the lamp 100 in the present invention comprises generally an arc tube 130, an upper shield 150, an upper housing 135, a return spring 120, a transformer 125, an igniter assembly or circuit board 110, a lower housing 140, and a lower shield 155. When fitted together, upper housing 135 and lower housing 140 encase circuit board 110, input spring 115, return spring 120 and transformer 125. Upper shield 150 and lower shield 155 further encase housings 135 and 140. Bulb base 131 is coupled to spring 120 when disposed in apertures in upper shield 150 and upper housing 135.

FIG. 1 illustrates an exemplary embodiment of the present invention. There is a circuit board 110 with a slit cut 112 through a portion of the circuit board 110. The slit 112 promotes electrical isolation of power input spring 115, thus preventing arcing. Slit 112 further promotes electrical isolation on circuit board 110, once potting material is added (see below). The use of the componentry on the circuit board 110 is typical for an igniter of an HID. Connected to the circuit board 110 are both power input spring 115 and the power return spring 120. Springs 115 and 120 are expandable. The springs, as taught by the present invention, are configured to receive and/or releasable couple with a standard P32d sized base 131 of an arc tube 130.

Also, as taught by the present invention, the input spring 115 and return spring 120 are can act in either a power input or power return, as is commonly known in the art of alternating current circuitry.

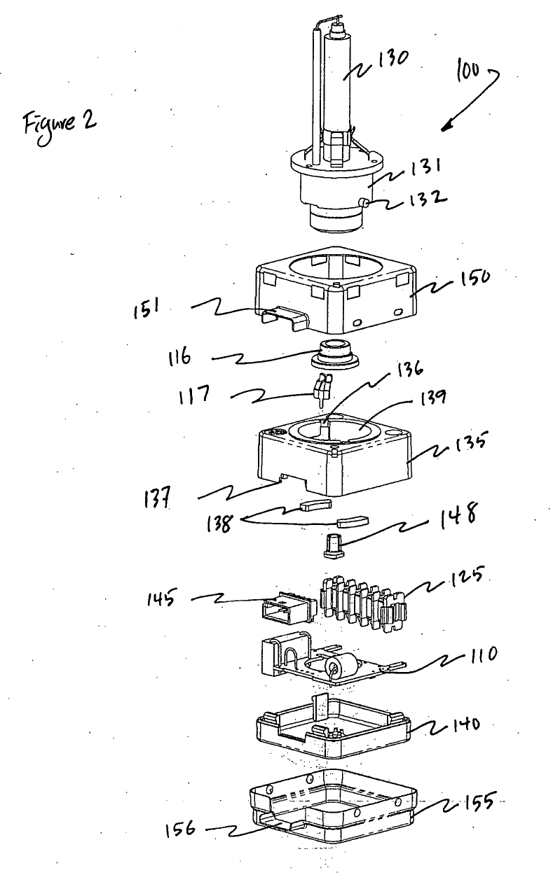

Also coupled to circuit board 110 is an ultra thin film insulated transformer 125. One embodiment of the transformer 125 is made of MEXCEL brand wire, purchased from Mitsubishi, using the M.E.D.I.S. wire insulation deposition process. For an example of such wire using this process, see U.S. Pat. No. 4,576,694 to Jidai. By utilizing this very thin wire and insulation system, the present invention teaches the ability to significantly reduce the size and/or space needed for a D1S-sized high voltage transformer while having a P32d-sized base 131 coupled thereto, thus allowing the integration of a P32d base and high voltage transformer to be integrated into a D1S-sized igniter housing. Base 131 is also configured with a fitting tab 132, so as to ensure the proper locking of the arc tube 130 with the housing 135 in hole 139. Due to the increased efficiency of the present invention's igniter circuit and associated reduced heat generation, a variety of bulb wattages can be used with the same circuit board. The present invention is compatible with burners having a rating range of preferably 25-100 watts. However, other wattage ranges may be utilized with variations in ballast and burners. As a result, the present invention can accept any off-the-shelf brand D2 burner with a P32d base, and convert it to a D1S bulb. Other embodiments of the transformer 125 can be configured having a similar small size but comprising types of wiring and arrangements so long as the transformer fits within the D1S-sized igniter housing. See FIG. 2.

To configure the present invention, the base 131 of the arc tube 130 is disposed in a hole 139 in the upper housing 135 and positioned adjacent to a return spring 120. Return spring 120 is expandable to receive corresponding return structure of base 131 for positive, press-fit contact. Return spring 120 is permitted to float or move so as to receive base 131, yet accurately position the spring 120 to the correct connection on circuit board 110. The structural walls of the housing also function to retain the spring in its proper relative location. To further aid in the alignment of base 131 and spring 120, an alignment slot 136 is disposed on the inner rim of the hole 139 of the upper housing 135, through which the fitting tab 132 is guided.

Also molded into the upper housing 135, is a connector slot 137 so as to allow connector fitting 145 to pass there through. Connector fitting 145 is configured to receive a power supply for the igniter. Lower housing 140 is coupled to the upper housing 135 to create a completely enclosed circuitry having the arc tube coupled thereto.

Upper shield 150 is coupled to lower shield 155. The upper shield 150 and lower shield 155 each have a connector shroud 151 and 156, respectively, through which connector fitting 145 passes.

As taught herein, the transformer may provide a turns ratio of 2:150 or 3:150 for generating up to 30,000+ volts. The turn ratio of transformer 125 is for generating up to 30,000 volts. Additionally, the lamp cold start up current may be as high as 3 Amperes RMS. Thus the copper coil size can be AWG#28 or 0.322 mm diameter to sustain the high current. The present invention solves the problem of how to wind the necessary heavy gauge coil windings into a small size high voltage transformer to facilitate the operation and structure of an off-the-shelf D2 device into a D1S bulb.

The ferrite material core of ignition high voltage transformer is zinc nickel sinter powder. The novel configuration of the transformer 125 of the present invention, includes the rectangular shaped ferrite core with the wire wrapped around the same rectangular form, this minimizes the space occupied by the transformer. The transformer 125 is placed adjacent the circuit board 110, so as to allow the circuit board 110 to sit above the housing 140. The transformer 125 however, is sufficiently spaced away from the housing wall 135 and 140 for high voltage isolation so that the potting can fill the 1 mm space. This prevents arcing from the high voltage generated by transformer 125 to the outer metal shield 150 and 155 which are typically grounded. The transformer's 125 coil winding shape is a parallelogram or preferably rectangular (to save space), so there is no core saturation when the high igniting pulse current goes through the core. The corners of the ferrite core are curved sufficiently as to not damage the wire during winding. The prior art uses a toroid core, which needs to have a gap to prevent saturation during the igniting stage. However, the toroid shape of the winding used in the prior art also can create an acoustic resonate noise when high start up current passes through the core. In contrast, the present invention teaches an open rectangular core, thus eliminating the noise associated with the prior art.

Also because the present invention teaches a flat rectangular shaped core, no magnetic field close loop is created, and thus no acoustic resonance sound created. Furthermore, the rectangular shaped core and windings of the present invention permit configuration of the transformer in a substantially smaller space.

The present invention further teaches using laminated 0.15 T×0.65 H wire having conductor resistance of 0.18 ohm/m. This reduces copper loss in the copper coil as compared to traditional round shaped copper coil wire. In addition, by stacking the flat wire winding there is no skin effect like that created when using round copper coil wire.

As taught by the present invention, the two or three wraps are wrapped with the wire lying broad side down so as to minimize the profile size of the transformer. However, the one hundred fifty wraps are wrapped so as the narrower side of the wire is pressed up against the transformer core. The present invention teaches one advantage of wrapping the wire in this manner thereby allowing the maximum number of wraps, and also to maximize the increase in voltage as allowed by the size and shape of the transformer.

Once the invention is completely assembled, a potting material is placed inside the housing to completely fill any void area therein. The devices are then placed in an evacuation chamber while the potting material remains fluid to remove substantially all of the air or air bubbles formed in the potting material, by drawing them to the surface. In this way, the present invention teaches substantially evacuating all the air from the igniter circuitry cavity. An epoxy resin may be used as a potting material because it is fluid and avoids the air bubbles or pin holes often associated with other potting materials after being placed in a vacuum.

The evacuation of the housing also increases the range of pressure conditions under which the present invention can operate. For example, the potting material increases the range of altitude at which the present invention can operate. Indeed the present invention teaches reliable high altitude cold starting and hot-restrike capability in reduced atmospheric pressure down to 1.05 PSIA (0.0714 ATM ) or 7.14% of normal atmospheric pressure as a result of the core transformer configurations and the potting material used. Not only does the use of an evacuation chamber during the potting process eliminate the air bubbles within the igniter housing, this process due to the removal of air from the potting compound eliminates possible sparking inside the circuitry housing during operation. Thus allowing the present invention to be used in aviation to over 60,000 feet, the potting material also acts as a heat sink, drawing heat away from the circuitry. This increases the longevity of the circuitry components, and also increases the tolerance of the igniter to heat and vibration. In addition, the potting material reduces a fire hazard from internal igniter arcing which could occur if flammable or explosive material is in the air.

Due to the unique structure and function of the igniter of the present invention, it is also robust enough for continuous sustained re-striking for continuous “pulsing” (On/Off) operation from 2 Hz rate down to ½ Hz pulsing rate. The increased efficiency of the igniter, along with the heat sink (potting), the present invention can be used as landing lights, or flashing lights, especially in use with aircraft, emergency vehicles, and in outer space for docking spacecraft or satellite.

Another feature of the present invention for many applications is the reduced weight of the present invention, with the present invention providing weight advantages over some devices presently known in the art.

Another embodiment of the present invention is depicted in FIG. 2. An additional feature of this embodiment is that the circuitry once positioned is encased in a dielectric potting material but done so to permit the selective insertion and removal of any bulb's P32d-sized base after potting. A number of bulb configurations such as D2, D3 and D4 bulb devices, and others, utilize a P32d-sized base. This embodiment contemplates the insertion and removal of the any bulb having a P32d-sized base from a 1S-sized igniter housing as needed or desired. As shown in FIG. 2, like members are given like numbers as those illustrated in FIG. 1.

As depicted in FIG. 2, arc tube 130 has a P32d-sized base 131 with fitting tabs 132. For installation, base 131 is disposed in hole 139 of upper housing 135. Upper housing 135 is disposed with alignment slot 136 to receive fitting tabs 132. Alignment slot 136 is configured to receive fitting tabs 132. Slot 136 has a substantially vertical and substantially horizontal portion. Tabs 132 are inserted into the substantially vertical portions of slot 136. Base 131 is rotated inside opening 139 such that guide tabs 132 are rotated into the horizontal portion of slot 136 into a locked position such that tabs 132 releasably lodge between upper housing 135 and rubber pads 138 disposed within upper housing 135. The locked position comprises the commonly used rise or bump in a horizontal portion of slot 136 adjacent pads 138 and rotating tabs 132 past the rise or bump to trap or lodge tabs 132. Tabs 132 also lodge between upper housing 135 and pads 138 such that rubber pads 138 are deformed when tabs 132 are pressed against them thereby holding tabs 132 in place via a positive-pressure application. To remove, tabs 132 are forced back over the bump by counter-rotation. Thus the P32d-sized base 131 can be selectively inserted and removed from the D1-sized housing as desired or needed. This constitutes means for selectively receiving a standard P32d-sized base of an arc tube.

As illustrated in FIG. 2, another point of contact between base 131 and circuit board 110 is disclosed. Contact 148 is disposed on lower housing 140 and protrudes through an opening in circuit board 110. Contact 148 is in electrical contact with circuit board 110. Contact 148 comprises a wall member defining an interior opening which receives a corresponding adjacent member of base 131 to facilitate proper electrical contact between base 131 and the D1S-sized igniter assembly. The wall member of contact 148 is flexibly biased in a direction so as to contact the electrical contact portion of base 131. The wall member of contact 148 can be any geometric shape desired. For example, to prevent spinning or slipping between contact 148 and opposite base 131, the cross section of the interior and/or of the exterior surface of the wall member of contact 148 could be a polygon. In the alternative, a corresponding, adjacent member of base 131 may be polygonally. While the illustrated configuration of contact 148 depicts contact 148 as defining an interior opening, a person of skill in the art would recognize that contact 148 could be a solid with a corresponding surface of base 131 disposed around contact 148 so long as the needed electrical contact was provided. Furthermore, a person of skill in the art would recognized that contact 148 need not comprise an annular or polygonally shaped wall member but could comprise one or more flexible, biased contact members.

Annular silicone rubber pad 116 is disposed about pin 148 to provide several features. Pad 116 acts as a seal to prevent unwanted moisture or gases from compromising any componentry of the assembly. Pad 116 also provides an electrical seal to prevent any undesired electrical arcing between opposing or adjacent components. Pad 116 also provides a mechanical bias or pressure when base 131 is inserted into housing 135 such that base 131 is pressed against pad 116.

In order to make electrical contact between arc tube 130 and circuit board 110, one or more outer contacts 117 are connected to circuit board 110 extend to contact the base of arc tube 130. Contact 117 is flexible and is biased toward base 131 of arc tube 130 such that when base 131 is inserted into or removed from housing 135, contact 117 is able to releasably make sufficient surface contact with base 131 to facilitate the electrical contact needed to transmit energy from the circuit board to arc tube 130.

As illustrated in FIG. 2, this alternative embodiment permits any bulb having a P32d-sized base to be selectively inserted and removed into a D1S-sized igniter housing. This provides a heretofore unrecognized ability and advantage to replace spent or damaged D2, D3 or D4 HID bulbs from a D1S-sized igniter housing without also replacing the D1S-sized igniter housing. This savings in cost, inspection, insertion, removal and servicing provides advantages not provided by prior art HID assemblies.

The forgoing embodiments are illustrative only. The scope of the present invention is set forth by the following claims. Persons of ordinary skill in the art will recognize that numerous embodiments can be configured within the spirit and scope of the present invention.

What is claimed:

1. A lamp apparatus comprising a standard burner releasably disposed within a D1S-sized igniter housing assembly.

2. The apparatus of claim 1 wherein the burner is coupled to the D1S-sized housing by one or more flexible contact members.

3. The apparatus of claim 1 wherein the burner is coupled to the D1S bulb assembly by disposing the base of the burner between releasable housing members.

4. The apparatus of claim 1 wherein the burner has a standard P32d base.

5. The apparatus of claim 2 wherein the one or more flexible contact members couple to a power supply.

6. A HID lamp assembly comprising:
a D1S-sized igniter housing wherein the housing is configured to releasably receive a P32d-sized base.

7. The assembly of claim 6 wherein a burner having a P32d-sized base is releasably disposed in the housing.

8. The assembly of claim 6 further comprising a circuit board disposed within the housing.

9. The assembly of claim 8 further comprising a transformer disposed within the housing and coupled to the circuit board.

10. A D1S-sized HID lamp assembly comprising:
a D1S-sized igniter housing; and
means for selectively receiving a standard P32d-sized base of an arc tube disposed in the igniter housing.

11. The assembly of claim 10 wherein a burner having a P32d-sized base is releasably disposed in the housing.

12. The assembly of claim 10 further comprising a circuit board disposed within the housing.

13. The assembly of claim 12 further comprising a transformer disposed within the housing and coupled to the circuit board
